(19) United States
(12) Patent Application Publication
(10) Pub. No.: US 2005/0288968 A1
(43) Pub. Date: Dec. 29, 2005

(54) Method and system for evaluating a cost for health care coverage for an entity

(76) Inventor: John Collins, Monrovia, CA (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/882,139

(22) Filed: Jun. 29, 2004

(51) Int. Cl. G06Q 40/00

(52) U.S. Cl. 705/4

(57) ABSTRACT

A method for evaluating a cost payable by an entity to secure a specific health care coverage. The method includes the steps of: obtaining starting information relative to at least one health-related attribute for the entity; based on the starting information, making an initial health risk assessment for the entity; charging the entity a first calculated amount for the specific health care coverage for an agreed term based upon the initial health risk assessment; before the end of the agreed term, making an updated health risk assessment based on updated information relative to at least one quantifiable health-related attribute for the entity; and determining whether an adjustment to the first calculated amount is warranted based on the updated health risk assessment.

### BACKGROUND OF THE INVENTION

1. Field of the Invention

This invention relates to health care and, more particularly, to a method of evaluating an appropriate amount to be paid by an entity for health care coverage. The invention is further directed to a system through which the method can be practiced.

2. Background Art

The increasing cost of health care in the United States, and elsewhere, has reached a crisis level. The past expectation by employees of a generous health benefits package is no longer a reality. Skyrocketing health care costs have left employers with essentially three options. First, employers can offer, and fully fund, attractive health care benefits. However, this may have to be done at the expense of profitability. Second, employers might demand a contribution from their employees towards these plans. Third, employers may shop for plans that are affordable by reason of having procedural or coverage limitations that generally make them unattractive to, and often impractical for, employees. The last two options may seriously impact an employer's ability to attract quality personnel. Candidates for employment are more and more investigating health care benefits and making decisions on employment that are more significantly affected by benefits packages than the nature of the actual job position. As a practical matter, offering a noncompetitive benefits package is not an option for most employers.

Unfortunately, group plans are handicapped by potentially even a small number of employees that are in high medical risk categories. For example, statistically, those that smoke or are in the obese category have significantly greater medically related problems than do nonsmokers and those at healthy weight levels. A handful of employees in this high risk category can, by themselves, impair an employer's ability to procure good and affordable medical coverage for the collective employee group.

The cost of medical insurance could be reduced to more affordable levels if the employees in the higher risk categories could modify or control their lifestyles, or conditions, to place them in lower risk categories. However, heretofore, the motivation to accomplish this has not existed. The profile of a particular group for which coverage is sought is nothing more than a snapshot of the medical state of all employees in that entity at the time application for coverage is made. From this snapshot, health risk is evaluated for the entity and premiums are set for the full term of the insurance coverage. Once an employer has signed on for coverage for a set term, there is little incentive, on the part of the insured entity, to make a concerted effort to reduce the risk category of employees, until the time of renewal. Even if employers gave incentives to employees to improve their risk category for the next renewal, there is little likelihood of success since any economic benefits could be realized only in the distant future.

From the standpoint of the insurance provider, group premiums are set at high levels with the inclusion of high risk individuals with the anticipation that these persons' medical conditions will remain substantially the same throughout the term of the coverage. Thus, the status quo is maintained through term and, as a result, the employer, employees, and insurance carrier all suffer financially. That is, rates remain high, requiring that the employer absorb the rates and/or pass them on to employees. Employees may get a less than desirable benefits package by reason of there being high risk persons in the insured group. From the standpoint of the insurance company, a high risk group produces many claims, which perpetuates the trend in upwardly spiraling insurance costs.

As a practical matter, using a snapshot “profile” of the individuals in an insured entity presents potential inequities for both the insurer and the insured. The insurance premium at the initiation of a policy may be based on a worst case medical state for the entity as it exists at the start of the term. If the conditions that accounted for high premiums are mitigated during the term, the insured will realize no benefit until there is renewal. On the other hand, if the condition of high risk individuals worsens, or other individuals in the group move into a higher risk category, the additional risk is borne by the insurer, possibly at a premium that is lower than one that would reflect the actual increased mid-term risk. To avoid this latter scenario, insurance companies may build into their premium assessment procedures a margin for error favoring the insurance company. In the former scenario, the insurance company realizes an unexpected benefit by reason of the insured entity being at lower risk than the premiums reflect.

All of the above factors have contributed to a dangerous trend in the industry. By reason of subjective analysis of risk and the ever changing status of risk for a particular entity, insurance premiums are often not appropriate at the start of a term and become even less appropriate as the term progresses in the event that the health profile for a particular entity changes. Ideally, the insurance industry would be able to monitor the changing health profile for a particular entity and adjust premiums, both up and down, as appropriate during a policy term. However, to date the industry has worked with the fixed model, described above, which has had an enormous detrimental impact, not only on the insurance industry, but on the way businesses now operate.

Those businesses that “self insure” face similar problems that stem from the inability to quantify health risks for a group and an unwillingness and inability to allocate the financial burden of health care based on individual risk. Those in a high medical risk category generally account for greater outlays toward medical treatment by the employer but are not expected to bear any extra financial burden. Thus, healthy individuals continue to bear the burden of high medical costs for which they are not responsible.

In conclusion, businesses and those providing medical care would both be best served by reducing the number of employees in the high risk category and/or allocating higher medically related costs to those in categories at a higher risk of incurring them. While the goal of a healthier work force is discussed commonly in the business world, no practical plan towards reaching this goal has been offered.

### SUMMARY OF THE INVENTION

In one form, the invention is directed to a method for evaluating a cost payable by an entity to secure a specific health care coverage. The method includes the steps of: obtaining starting information relative to at least one health-related attribute for the entity; based on the starting information, making an initial health risk assessment for the entity; charging the entity a first calculated amount for the specific health care coverage for an agreed term based upon the initial health risk assessment; before the end of the agreed term, making an updated health risk assessment based on updated information relative to at least one quantifiable health-related attribute for the entity; and determining whether an adjustment to the first calculated amount is warranted based on the updated health risk assessment.

In one form, the step of obtaining starting information involves requiring the generation of quantitative starting information relative to at least one health-related attribute.

The step of requiring the generation of quantitative starting information may involve requiring use of an instrument to take at least one measurement to generate data representative of a state for at least one health-related attribute.

The step of obtaining starting information may involve obtaining starting information relative to an entity's heart condition.

The step of obtaining starting information may involve obtaining starting information relative to an entity's body composition or blood sugar level.

The method may further include the step of adjusting the first calculated amount based upon the updated health risk assessment.

The method may further include the step of requiring that the entity submit for consideration quantitative updated information relative to at least one health-related attribute at a specific time within the agreed term to facilitate the step of determining whether an adjustment to the first calculated amount is warranted.

The method may further include the step of maintaining a database for the entity in which the starting and updated information is stored.

The method may include the step of providing a web-enabled system through which updated information can be directed to the database for analysis.

The step of obtaining starting information may involve requiring the generation of quantitative starting information through an instrument that is capable of communicating the starting information to the database.

The step of obtaining starting information may involve requiring the generation of quantitative information through an instrument that is web-enabled and capable of communicating the starting information to the database over the Internet.

The step of obtaining updated information may involve requiring the generation of quantifiable updated information through an instrument that is capable of communicating the updated information to the database.

The step of obtaining updated information may involve requiring the generation of quantifiable updated information using the same type of instrument that is used to generate the quantitative starting information.

The method may further include the step of requiring use of at least one instrument to generate data that is representative of the starting and updated information.

The method may further include the steps of maintaining a database for the entity in which the data representative of the starting and updated information can be stored and requiring that the data generated by the at least one instrument be communicated to the database through the instrument.

The method may further include the step of verifying that the data representative of the starting and updated information is generated for the same entity.

The method may further include the step of pre-establishing parameters for determining whether an adjustment to the first calculated amount is warranted.

The method may further include the step of linking the at least one instrument to the database through the Internet whereby the data can be generated remotely and conveyed to the database.

The method may further include the step of requiring that the entity verify the integrity of the data representative of the starting and/or updated information.

The method may include the step of spot checking the integrity of the data representative of the starting and/or updated information by using at least one instrument to generate test data that is representative of the starting and/or updated information, and making a comparison between the test data and the data representative of the starting and updated information that was communicated to the database.

The method may include the step of providing web-accessible, health-related information for the entity.

The method may include the step of providing a web-accessible database to which the starting and/or updated information is communicated via the Internet.

The method may include the step of providing a server to which the data is communicated and containing general health-related information that is accessible by the entity.

The method may include the step of providing customized health-related information to the entity based upon data communicated by the entity to the server.

The method may further include the step of providing a server. The step of requiring use of an instrument may involve requiring use of an instrument that is capable of taking a measurement and generating a signal to the server that is not in human readable form and causing the signal to be converted by the server to a human readable form.

The first calculated amount may be at least one of (a) a co-payment amount; (b) a deductible; and (c) a premium.

The entity may be a single person or may be made up of a plurality of persons.

The invention is further directed to a system for evaluating a cost payable by an entity to secure a specific health care coverage. The system includes a server at a first site and an instrument at a second site capable of taking at least one measurement and generating a signal representative of a state for at least one health-related attribute for an entity to the server. The server is capable of processing a signal representative of a state for the at least one health-related attribute for the entity and calculating a first recommended amount to be paid by the entity to secure the specific health care coverage based upon a reference amount using a reference state for the at least one health-related attribute.

The signal generated by the instrument may be in non-human readable form and is converted by the server to a human readable form.

The server may be a web server.

The web server may communicate health-related information to the entity.

In one form, the web server communicates customized health information to the entity based upon the signals generated by the user to the web server.

In one form, the web server processes different signals representative of the state for the at least one health-related attribute for the entity at different time periods and processes the different signals to calculate a recommended updated amount appropriate for the entity in the event that a later signal indicates that there is a change in the state for the at least one health-related attribute for the entity from a first state for the at least one health-related attribute for the at least one entity based on a signal representative of the state for the at least one health-related attribute for the entity that is generated and communicated to the web server prior in time to the communication of the later signal to the web server.

The invention is further directed to a system for evaluating a cost payable by an entity to secure a specific health care coverage. The system includes a server to which data relative to at least one health-related attribute for an entity can be communicated. The server is capable of processing the data communicated by the entity to facilitate risk analysis so as to allow a quantified analysis of an appropriate amount to be paid by the entity, based on the communicated information, to be made. The system further includes an instrument for taking at least one measurement to generate data representative of a state for at least one health-related attribute that is communicated to the server.

In one form, the instrument generates a signal that is not in human readable form and is converted by the server to a human readable form.

The server may communicate-health-related information to the entity.

In one form, the server communicates customized health information to the entity based upon the signals generated by the entity to the web server.

In one form, the server communicates customized health-related information to the entity based upon the signal generated to the server.

In one form, the server processes different signals representative of the state for the at least one health-related attribute for the entity at different time periods and processes the different signals to calculate a recommended updated amount appropriate for the entity in the event that a later signal indicates that there is a change in the state for the at least one health-related attribute for the entity from a state for the at least one health-related attribute for the at least one entity based on a signal representative of the state for the at least one health-related attribute for the entity that is generated and communicated to the web server prior in time to the communication of the later signal to the server.

The server may communicate health-related information to the entity in response to a query from the entity.

The server may be a web-based server.

The invention is further directed to a method of evaluating a cost payable by one individual in a group, consisting of a plurality of individuals, to secure a specific health care coverage. The method includes the steps of: obtaining starting information relative to at least one health-related attribute for the plurality of individuals including the one individual; based on the starting information, making an initial health risk assessment for each of the plurality of individuals including the one individual; at one point in time charging the one individual a first calculated amount for the specific health care coverage based upon the initial health risk assessment when compared to the initial health risk assessment for the other individual or individuals in the group; establishing criteria for the one individual to be able to secure the specific health coverage by paying the first calculated amount; and at a second point in time, after the first point in time, determining whether the one individual has met the established criteria.

The step of establishing criteria may involve setting health-related goals for the one individual.

The step of setting health-related goals may involve requiring the one individual to achieve specific quantifiable results relative to at least one health-related attribute.

Alternatively, the step of setting health-related goals may involve requiring the one individual to embark upon a specific health-related regimen.

The method may further include the steps of obtaining updated information relative to at least one health-related attribute for the one individual, based on the updated information making an updated health risk assessment for the one individual, and charging the one individual a second calculated amount for the specific heath care coverage, that is different than the first calculated amount, based upon the difference in the initial and updated health risk assessments for the one individual.

### BRIEF DESCRIPTION OF THE DRAWINGS

FIG. 1 is a schematic representation of a system for evaluating cost payable by an entity to secure health care coverage, according to the present invention;

FIG. 2 is a flow diagram representation of one method of evaluating cost to secure health care coverage through the system in FIG. 1, as performed by the insurer;

FIG. 3 is a flow diagram representation of the method in FIG. 2 in more detailed form;

FIG. 4 is a flow diagram representation of a method of taking starting and updated measurements utilizing instrumentation through which cost to secure health care coverage can be evaluated;

FIG. 5 is a flow diagram representation of a method through which information is processed by a web server, corresponding to the method in FIG. 4;

FIG. 6 is flow diagram representation of one method for an entity to utilize the web server to access health-related information;

FIG. 7 is a flow diagram representation of a method for receiving health-related information from the server based upon starting data/information input;

FIG. 8 is a flow diagram representation, similar to that in FIG. 7, wherein information is received based on a change in data/information;

FIG. 9 is a flow diagram representation of a method for allowing an entity to access general health-related information on the web server; and

FIG. 10 is a flow diagram representative of a method for evaluating a cost payable to secure health care coverage, according to the invention under a self-insurance plan.

### DETAILED DESCRIPTION OF THE DRAWINGS

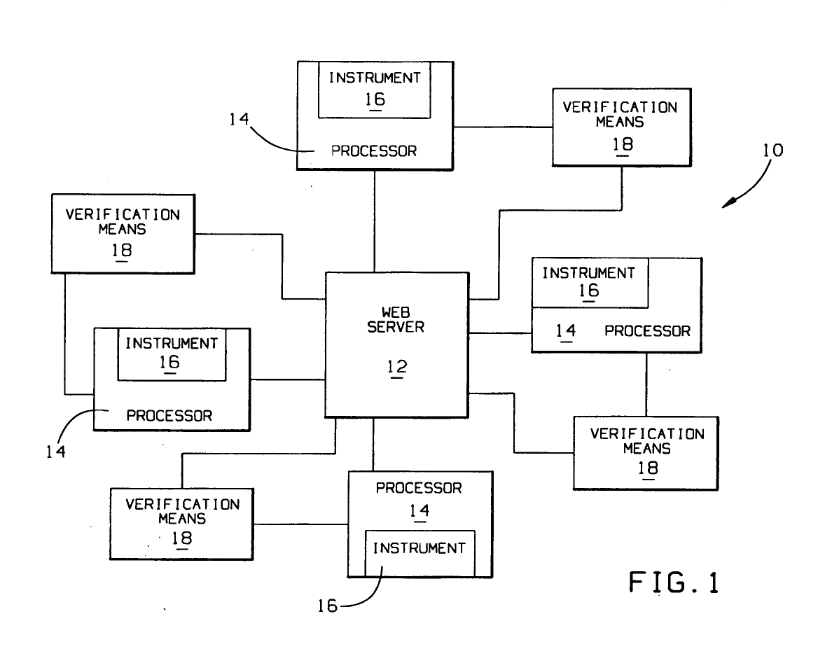

In FIG. 1, an interactive web-based system for evaluating a cost payable by an entity to secure specific health care coverage is shown at 10. The system consists of a server 12 to which data/information relative to at least one health-related attribute for an entity can be communicated from one, or a plurality of, remote locations. In this embodiment, the server 12 is shown to be web-based. However, this is not a requirement. As used herein, “entity” may be either a single individual, or a number of individuals, such as a group that is employed by a particular business, or an entire business. The cost is considered “payable”, as used herein, if it is a cost to be paid by one or more individuals to: a) a medical care provider; b) an insurance carrier; or b) an employer/business. The obligation may be direct to the medical care provider, insurance carrier, etc., or indirect as by employees through an employer, either individually or collectively. In this representative system, four remote processors 14 are shown in communication with the web server 12. The processors 14 may be individual PC's that may be located at a home, a business, or elsewhere.

The web server 12 is capable of processing data/information relative to at least one health-related attribute for an entity. The health-related attribute may be any attribute that would influence (a) a decision as to whether or not to provide health care coverage to an entity and/or (b) a calculation of an appropriate cost payable by such an entity for a specific desired coverage. This cost may be a co-payment amount, a deductible, a premium, etc. The particular health-related attribute relative to which the data/information is generated may be body composition, heart rate, blood sugar level, etc. The data/information may be relative to a steady state condition. Alternatively, data/information may be communicated to the web server 12 representing an entity's response to activity, or other stimulus, over a defined time period. A more detailed, but not exhaustive, explanation of health-related attributes contemplated to be considered, according to the invention herein, is disclosed in U.S. patent application Ser. No. 09/518,781, the disclosure of which is incorporated herein by reference.

The server 12 may have software applications which facilitate risk analysis for health care or insurance providers by quantitatively analyzing the submitted data/information and calculating an appropriate amount to be paid by the entity for specific, desired health care coverage. This calculation may be made based upon computer models prepared, as by the insurance or health care industry, that correlate particular health states to medical conditions requiring specific treatments, and identify anticipated treatment costs.

The system 10 has instruments 16 through which measurements are taken with respect to the entity to generate data/information representative of a state for at least one health-related attribute. The instruments 16 are linked to the web server 12 through the processors 14. In one form, the instruments 16 are self-contained and capable of generating data/information in human readable form. For example, an instrument 16 may be a blood pressure monitor through which a blood pressure reading can be taken and conveyed through a processor 14 to the web server 12 for processing thereby.

Alternatively, and more preferably, the instruments 16 are a type as disclosed in U.S. application Ser. No. 09/518,781. Specifically, the instruments 16 disclosed therein generate a data signal that is not in human readable form. The web server 12 has software applications which are capable of converting the signal to a human readable form, usable as by that entity responsible for paying for medical treatment, be it an insurance carrier, a self-insured business, etc. The converted data may be communicated back to the entity through the processor 14.

With this arrangement, instruments 16 can be made with relatively inexpensive designs, since they do not require extensive processing capabilities. Further, by reason of generating a signal that cannot be interpreted without conversion, the entity will not be prone to tampering with the signal, whereby the entity responsible for paying for medical treatment gets an accurate understanding of the medical condition for the particular entity, as in anticipation of offering medical coverage.

As shown in FIG. 1, verification means 18 may also be provided in association with each station from which data/information is communicated to the web server 12. The verification means 18 may take a wide range of forms that is virtually unlimited so long as it is capable of verifying that the data/information communicated to the web server 12 relates to a particular entity. As just one example, one of the instruments 16 may have the ability to identify a user by fingerprints. A particular entity would have to have his/her fingerprints identified before a measurement can be taken by the instrument and a signal generated to the web server 12 indicative of the state for a particular health-related attribute that is being monitored.

Alternatively, an individual that is a representative of an organization may be given the task of physically monitoring the entity for which measurements are being taken to confirm the relationship between the entity and the data/information. A controlling agreement may specify that any fraudulent inputting of data/information would void any obligation for coverage so that the entity would forfeit any rights to health care coverage that were previously negotiated.

As a further alternative, a representative of the entity obligated to provide health care coverage may monitor the measurement process to verify the match between the entity and the particular data/information. Regular or spot checking of data/information may be carried out.

The web server 12 may also function to provide feedback to an entity based upon data/information communicated and/or provide retrievable information related to general health maintenance, as may be periodically requested by an entity. For example, in the former case, if an entity's data/information is indicative of a condition of high blood pressure, the web server may link the entity to a page having information related to high blood pressure. Through this mechanism, the entity may become educated about the causes of high blood pressure. Alternatively, the entity may be provided information relative to suggested programs for controlling or reducing blood pressure. As a further alternative, the entity may be provided information relative to physicians skilled in the treatment of a particular condition, drugs used for treatment, etc. The feedback from the web server 12 with this information may be customized and automatic upon the communication of the data/information from the entity to the web server 12 regarding the state of a health-related attribute. Alternatively, this information may be accessed through a specific or general request or query from an entity.

Still further, the web server 12 may include a host of health-related information, as described for example, in U.S. application Ser. No. 09/518,781. This information may relate to virtually any health-related topic and may be included on the web server 12 to be accessed by any entity. Access to this information may be a privilege attendant securing medical insurance and, in that event, is beneficial to both the insured and the insurer by potentially educating and encouraging an entity to embark upon a regimen that improves health and thus reduces risk of future heath-related problems. Alternatively, rights to access the information may be otherwise negotiated by an entity.

It should be understood that the system 10 in FIG. 1 is just a representative system. The system 10 may be set up for a single entity or for a vast network of users. The system 10 offers the opportunity for an insurer, whether an employer or unrelated third party, to periodically evaluate the medical state of the insured/covered entity. The evaluation may be done on a regular basis, such as monthly, or at any specified interval. By doing so, adjustments in an entity's financial obligation for coverage, both up and down as appropriate, can be made throughout the term of a particular policy. Rebates may be paid as a further incentive to the lowering of health-related risk. This accrues to the benefit of both the insurer and the insured. In the case of the insurer, risk assessment can be more realistically quantified on an on-going basis through a particular term. If risk of claim goes up, the insured may be required to assume an additional burden by way of an increased premium, co-pay, deductible, or any other monetary obligation associated with coverage.

If the risk goes down, the possibility of a claim diminishes and the insured may thus be afforded a reduced financial obligation mid-term to reflect this. At the same time, the insured entity is given an incentive to, at all times, improve the overall health profile for that entity, for which a monetary advantage can be realized mid-term, before a new policy is written or an agreement is reached.

The invention will be described hereinbelow with respect to a conventional “insurer/insured” relationship. However, it should be understood that this description is intended to encompass any cooperating entities, with one obligated to provide an agreed specific coverage for medical or dental care, and the other financially obligated to pay directly or indirectly for this coverage. For simplicity, the basic insurance relationship will be used as a model in the generic description.

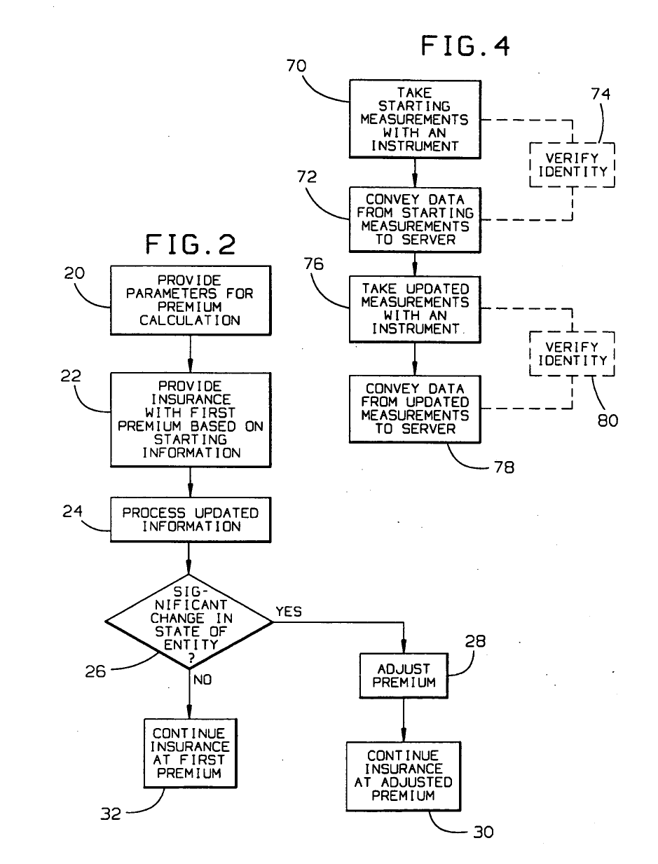

As shown in FIG. 2, in anticipation of entering into a relationship, or at the start of a particular policy, the insurer may provide to the insured/potential insured, parameters for premium calculation, as shown at block 20. This may afford to the insured/potential insured guidelines for calculations of the initial premium and guidelines for reducing premium before the end of term.

The insurer obtains starting information relative to at least one health-related attribute for the entity and provides insurance with a first premium based upon the starting information, as shown at block 22. As shown at block 24, at some point within the term for a particular policy, updated information is obtained from the entity and processed.

The updated information is compared with the starting information and, based upon preestablished guidelines, a calculation is made as to whether an adjustment of premium is in order. As indicated at block 26, if the change in state for the entity is significant, an adjustment to the premium, up or down, is made at block 28. The insurance coverage may be continued at the adjusted premium rate, as shown at block 30, for the remainder of the term, or until another evaluation is made. If no significant change in state occurs, the insurance coverage is continued at the first premium, as shown at block 32, either to the end of the term, or until a further evaluation is made.

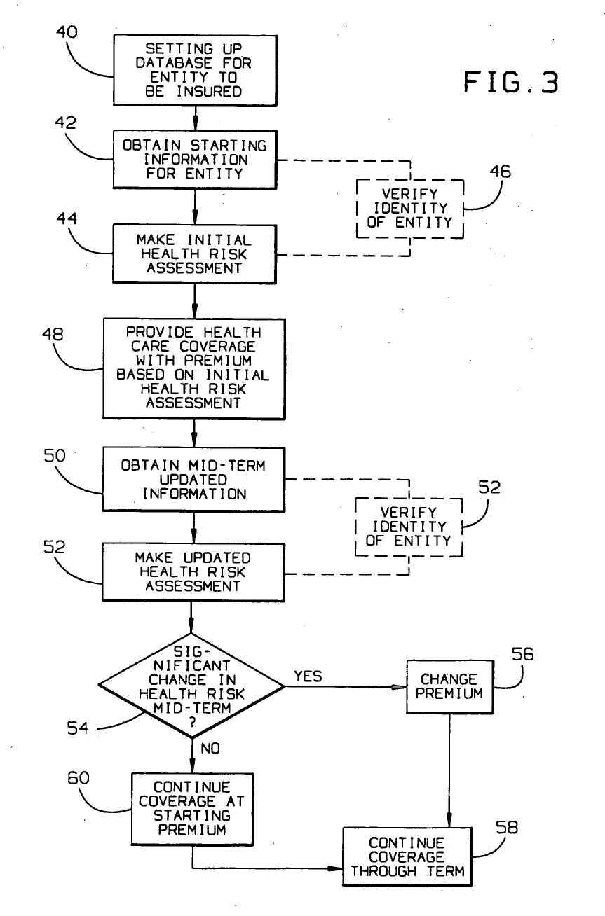

A more detailed explanation of a method for evaluating a health-insurance premium, payable by an entity to secure a specific coverage, as by using the system 10, is shown in FIG. 3. As shown at block 40, a database is set up for the entity to be insured. As shown at block 42, starting information for the entity is obtained by any appropriate means/process. The starting information may be any information relative to at least one health-related attribute for the entity that may be generated through an instrument 16, as previously described, or by a physician or other personnel.

Based upon the starting information, an initial health risk assessment is made, as indicated at block 44. This assessment may be made on an ad hoc basis or, alternatively, a recognized industry standard can be utilized to provide a reference for calculating premium based upon a particular profile. If appropriate, a verification may be required, as shown at block 46, to confirm that the starting information relates to a specific entity. Once the health risk assessment is completed, and a decision is made to offer insurance, coverage is provided with a premium based upon the initial health risk assessment relying upon the starting information, as shown at block 48, as for a defined term.

The insurer and insured may agree that the insurer will have the opportunity to either randomly, or at a specified interval or intervals mid-term, reassess health risk for the entity. The right of reassessment may also be afforded the insured. To do so, mid-term updated information on the health status of the entity is obtained, as shown at block 50. Preferably, the mid-term updated information is obtained using the same means as used for obtaining the starting information shown at block 42. The relationship between the information and the entity may be verified, as shown at block 52. Based upon the updated information, an updated health risk assessment is made, as shown at block 52.

At block 54, a query is made as to whether any change in health risk for the entity is significant. If the answer to the query is yes, the premium is changed, as shown at block 56, and thereafter the coverage is continued through term, as indicated at block 58. As previously noted, the guidelines for a change in a particular profile for an entity which justifies a change in premium may be agreed to ahead of time and quantified so that results are predictable. Web server 12 may have software applications which can be customized or designed by the industry to afford meaningful standards for premium calculation and recalculation. If no significant change in the health status for a particular entity occurs, the coverage can be continued at the starting premium, as indicated block 60. The reassessment may be made any number of times during a given term as the insured and insurer may agree to. The reassessment may dictate termination of coverage if risk has increased significantly.

As previously noted, the starting and updated measurements can be taken by the instruments 16, which generate signals to the web server 12 that must be converted, or by instruments that produce human readable results which can be communicated through the processors 14 to the web server 12. While either of these methods is contemplated, it is preferred that the former be utilized, primarily for purposes of consistency and integrity.

As shown in FIG. 4, the starting measurements may be taken with an instrument 16, as shown at block 70. The instrument 16 produces a signal that is representative of a state for at least one health-related attribute that is communicated to the web server 12 for conversion to a meaningful form, as shown at block 72. With this arrangement, there is no conversion or interpretation of measurements at the particular site/station at which the processor 14 is located. For integrity purposes, a verification of the identity of the entity may be required, as shown at block 74.

As shown at block 76, updated measurements can be taken as with the same type, or the same, instrument 16 used to take the starting measurements. The updated data/information is conveyed through the processor 14 to the web server 12 as shown at block 78. Through an appropriate software application, a comparison between the starting and updated information can be made to ascertain whether an adjustment in premium is in order. The identity of the entity may be submitted and the updated information may be verified as shown at block 80.

The operation of the web server 12 is shown in FIG. 5. As shown at block 90, the web server 12 receives the starting data/information from the processor(s) 14. As shown at block 92, the starting information is processed and an appropriate calculation is made for a premium based upon a comparison with stored reference information, as shown at block 92. The data/information can be conveyed in a form wherein it is not required to be converted. Alternatively, as shown at block 94, the starting information may be conveyed to the web server 12 so that it must be converted thereby or in a separate process.

As shown at block 96, the web server 12 receives updated information and, using the same, or a similar software application, processes the updated information and recalculates an appropriate premium, as shown at block 98, based upon the updated information. Again, the updated information may be in a form that does not require conversion or, alternatively, may be converted, as shown at block 100.

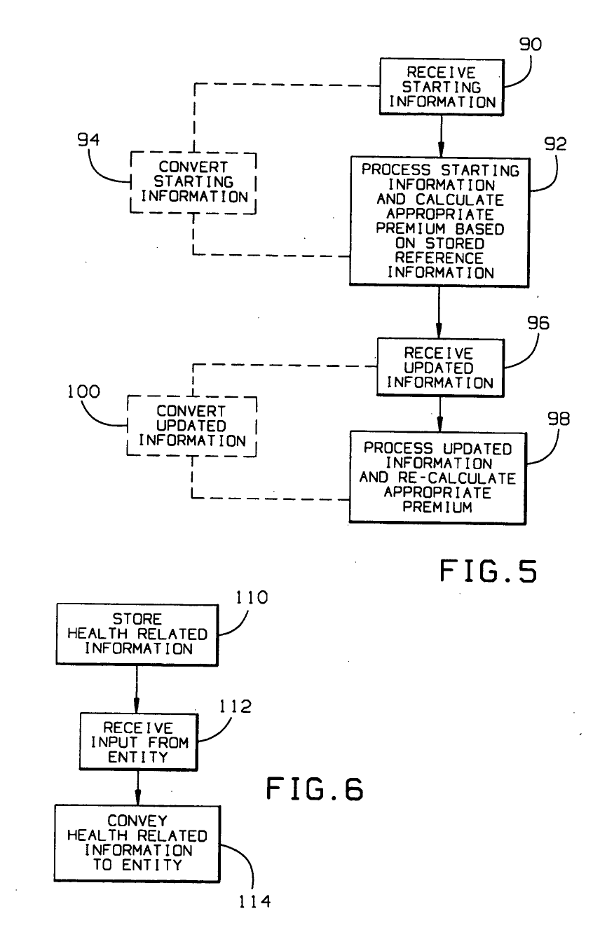

A further function of the web server 12 is shown at FIG. 6. In the web server 12, health-related information covering a wide range of topics, may be stored, as shown at block 110. As shown at block 112, an entity seeking health-related information may input to the web server 12 and conduct a search for the desired information, as shown at block 112. Access to this information on the web server 12 may be limited to insured entities or potentially insured entities that are given appropriate access capability. In response to the input from the entity at block 112, the health-related information is conveyed to the entity, as shown at block 114, as through the processors 14.

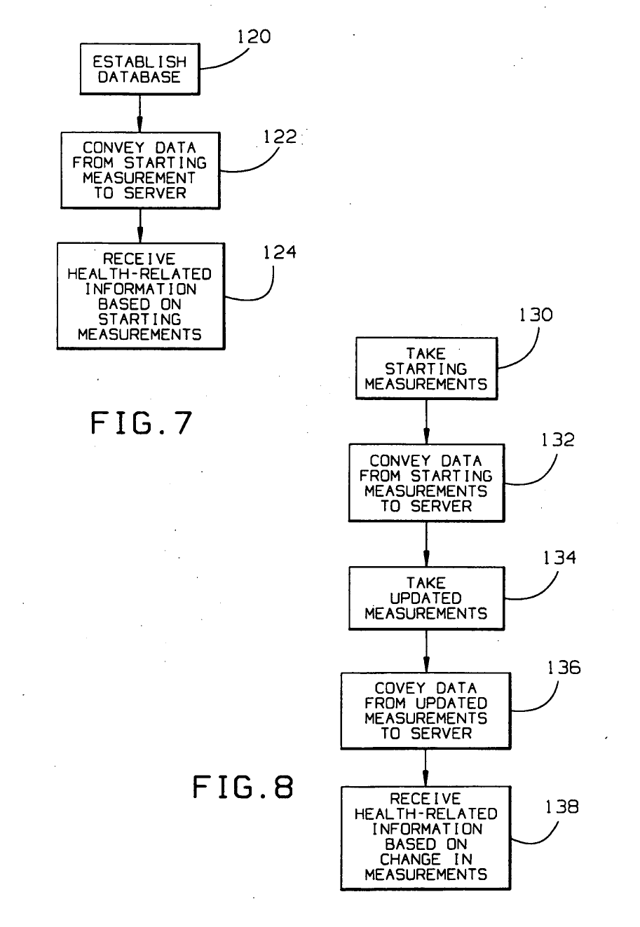

The web server 12 may include software applications and be programmed to permit the method shown in FIG. 7 to be carried out. As shown at block 120, an entity establishes a database in the web server 12. Data/information relative to at least one health-related attribute for the entity is conveyed to the server 12. The web server 12 is programmed to analyze the data/measurements input by the entity and to convey meaningful, customized, health-related information relative to that particular entity's state or infirmity. As shown at block 124, the entity receives this information that is customized, as to assist in the start of a regimen that may improve the entity's health state. Medication and/or physician information, or other pertinent medical information, may be communicated to the entity.

Another method that can be practiced using the system 10 is shown in FIG. 8. As shown at block 130, starting measurements for an entity are taken. Data/information from the starting measurements is conveyed to the server, as shown at block 132. On a subsequent date, updated measurements are taken, as shown at block 134, and data/information representative thereof is conveyed to the server, as shown at block 136. The server 12 is programmed to specifically focus on a change in state and to provide to the entity customized health-related information pertinent thereto, which is received by the entity, as shown at block 138.

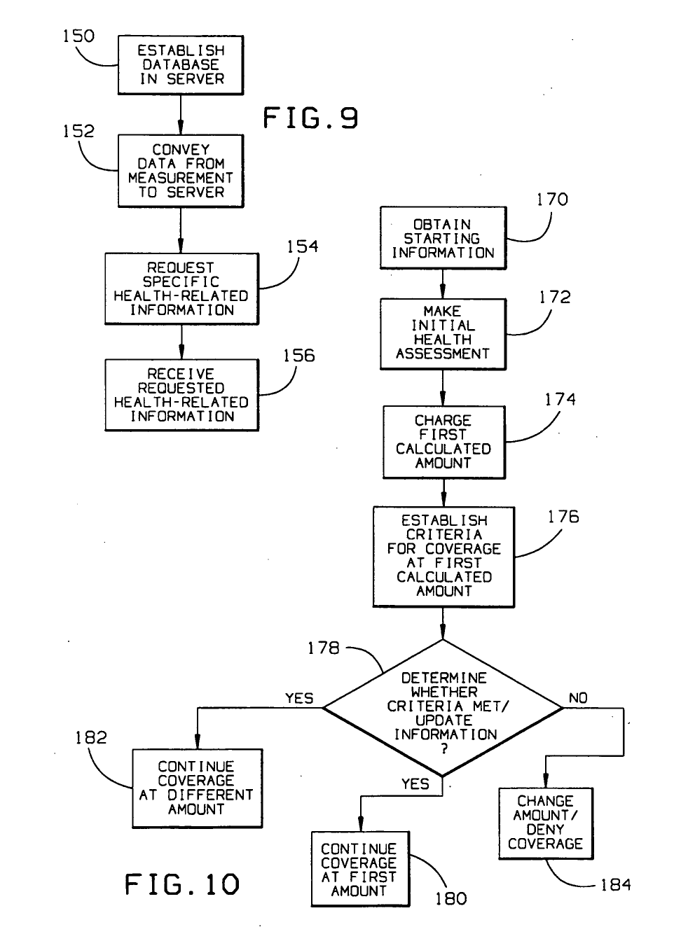

The system 10 may also provide a more general research capability for any entity interested in any health-related issue. For example, as shown in FIG. 9, at block 150, a database may be set up with a wide range of general information regarding specific diseases, conditions, etc., exercise regimens, medical treatments, physician networks, etc. Virtually any health-related information may be provided on the web server 12 to be accessed through the processors 14.

The entity may, at any time, convey data/information to the server, as shown at block 152, whether or not this conveyance is done in anticipation of a health risk reassessment or not. Thus, the individual entities may use the system 10 as a helpful tool to assist improvement in health, apart form the goal of obtaining a premium adjustment.

As further shown in FIG. 9, the entity may request any type of health-related information, as shown at block 154, of interest to the entity without inputting information/data as shown at block 152. A response to the request for information is received by the entity, as shown at 156, and may be used as desired.

The invention affords the opportunity for ongoing monitoring of a medical state for an entity that is seeking, or has obtained, insurance for medical coverage. By periodically monitoring the medical state of the entity, premiums for health care coverage can be appropriately adjusted to reflect the actual risk that the entity represents at any point in time. By pre-establishing the standards for the premium calculation and re-calculation, more predictable standards for premiums in the industry may result. By establishing more uniformity in the industry, abusive practices of extracting inappropriately high premiums may be avoided. At the same time, the system affords ongoing incentive for entities to improve their overall health profile so that premiums can be controlled. Improved overall health in the working population not only accounts for potentially lower health care costs, but improves productivity. Employers can incent employees to improve their health profile. Better health translates into fewer claims and lower medical costs. On a national scale, the positive effects of health improvement on businesses could be enormous.

By utilizing appropriate instrumentation, information relative to the various health-related attributes can be quantified. By establishing guidelines for calculating premiums, and utilizing the same instrumentation for the generation of starting data/information and updated data/information, predictability for both the insured and insurer may result. Verification steps may be taken to avoid any fraudulent practices.

As noted above, the above description has been intended to be generic in nature to include any entities, one of which is paying for health care coverage, and the other which is obligated to directly or indirectly provide the same. This relationship may be one of insured/insurer, or otherwise. The advantages of the invention in a self insurance program will now be described with respect to FIG. 10.

The method contemplates evaluating a cost payable by one individual or a group, consisting of a plurality of individuals, to secure a specific health care coverage. As shown at block 170, starting information relative to at least one health-related attribute for the plurality of individuals, including the one individual, is obtained. Based on the starting information, an initial health risk assessment for each of the plurality of individuals, including the one individual, is made, as shown at block 172.

At one point, the one individual is charged a first calculated amount for a specific health care coverage based upon the initial health risk assessment and compared to the initial health risk assessment for the other individual or individuals in the group, as indicated at block 174. As shown at block 176, criteria are established for the one individual to be able to secure the specific health coverage by paying the first calculated amount.

As shown at block 178, at a second point in time, after the first point in time, it is determined whether the one individual has met the established criteria. The established criteria may be any of a number of different health-related goals for the one individual. The criteria may be a requirement that the one individual achieves specific quantifiable results relative to at least one health-related attribute. Alternatively it may be required that the individual embark upon a specific health-related regimen. The determination as to whether the criteria have been met may be part of obtaining updated information relative to at least one health related attribute as shown also at block 178. From this, an updated health risk assessment is made.

Based upon the updated information, If it is determined that the pre-established criteria have been met, coverage can be continued at the first amount, as shown at block 180. If expectations are exceeded, or results are slightly less than expected, the coverage can be continued at a different calculated amount, as shown at block 182. If the criteria have not been met, future coverage may be denied, as shown at block 184, or the amount to be paid may be increased.

With the method described in FIG. 10, an employer is afforded an opportunity to self insure with specific controls upon employees. Employees at high risk can be charged higher amounts for coverage. Employees will be incented to improve their health profile. This potentially results in a healthier overall group of employees, which ultimately may improve productivity. Those in the healthier categories reap the benefits of their good health by potentially paying less to be covered by an employer for health related costs.

The foregoing disclosure of specific embodiments is intended to be illustrative of the broad concepts comprehended by the invention.

1. A method for evaluating a cost payable by an entity to secure a specific health care coverage, the method comprising the steps of:
obtaining starting information relative to at least one health-related attribute for the entity;
based on the starting information, making an initial health risk assessment for the entity;
charging the entity a first calculated amount for the specific health care coverage for an agreed term based upon the initial health risk assessment;
before the end of the agreed term, making an updated health risk assessment based on updated information relative to at least one quantifiable health-related attribute for the entity; and
determining whether an adjustment to the first calculated amount is warranted based on the updated health risk assessment.

2. The method for evaluating a cost payable by an entity to secure a specific health care coverage according to claim 1 wherein the step of obtaining starting information comprises requiring the generation of quantitative starting information relative to at least one health-related attribute.

3. The method for evaluating a cost payable by an entity to secure an specific coverage according to claim 2 wherein the step of requiring the generation of quantitative starting information comprises requiring use of an instrument to take at least one measurement to generate data representative of a state for at least one health-related attribute.

4. The method for evaluating a cost payable by an entity to secure an specific coverage according to claim 1 wherein the step of obtaining starting information comprises obtaining starting information relative to an entity's heart condition.

5. The method for evaluating a cost payable by an entity to secure a specific coverage according to claim 1 wherein the step of obtaining starting information comprises obtaining starting information relative to an entity's body composition.

6. The method for evaluating a cost payable by an entity to secure a specific coverage according to claim 1 wherein the step of obtaining starting information comprises obtaining starting information relative to an entity's blood sugar level.

7. The method for evaluating a cost payable by an entity to secure a specific coverage according to claim 1 further comprising the step of adjusting the first calculated amount based upon the updated health risk assessment.

8. The method for evaluating a cost payable by an entity to secure a specific coverage according to claim 1 further comprising the step of requiring that the entity submit for consideration quantitative updated information relative to at least one health-related attribute at a specific time within the agreed term to facilitate the step of determining whether an adjustment to the first calculated amount is warranted.

9. The method for evaluating a cost payable by an entity to secure a specific coverage according to claim 1 further comprising the step of maintaining a database for the entity in which the starting and updated information is stored.

10. The method for evaluating a cost payable by an entity to secure a specific coverage according to claim 8 further comprising the step of providing a web-enabled system through which updated information can be directed to the database for analysis.

11. The method for evaluating a cost payable by an entity to secure a specific coverage according to claim 8 wherein the step of obtaining starting information comprises requiring the generation of quantitative starting information through an instrument that is capable of communicating the starting information to the database.

12. The method for evaluating a cost payable by an entity to secure a specific coverage according to claim 8 wherein the step of obtaining starting information comprises requiring the generation of quantitative information through an instrument that is web-enabled and capable of communicating the starting information to the database over the Internet.

13. The method for evaluating a cost payable by an entity to secure a specific coverage according to claim 8 wherein the step of obtaining updated information comprises requiring the generation of quantifiable updated information through an instrument that is capable of communicating the updated information to the database.

14. The method for evaluating a cost payable by an entity to secure a specific coverage according to claim 11 wherein the step of obtaining updated information comprises requiring the generation of quantifiable updated information using the same type of instrument that is used to generate the quantitative starting information.

15. The method for evaluating a cost payable by an entity to secure a specific coverage according to claim 12 wherein the step of obtaining updated information comprises requiring the generation of quantitative information through the same type of instrument that is used to generate the quantitative starting information.

16. The method for evaluating a cost payable by an entity to secure a specific coverage according to claim 8 further comprising the step of requiring use of at least one instrument to generate data that is representative of the starting and updated information.

17. The method for evaluating a cost payable by an entity to secure a specific coverage according to claim 16 further comprising the steps of maintaining a database for the entity in which the data representative of the starting and updated information can be stored and requiring that the data generated by the at least one instrument can be communicated though te instrument to the database.

18. The method for evaluating a cost payable by an entity to secure a specific coverage according to claim 17 further comprising the step of verifying that the data representative of the starting and updated information is generated for the same entity.

19. The method for evaluating a cost payable by an entity to secure a specific coverage according to claim 1 further comprising the step of pre-establishing parameters for determining whether an adjustment to the first calculated amount is warranted.

20. The method for evaluating a cost payable by an entity to secure a specific coverage according to claim 17 further comprising the step of linking the at least one instrument to the database through the Internet whereby the data can be generated remotely and conveyed to the database.

21. The method for evaluating a cost payable by an entity to secure a specific coverage according to claim 17 further comprising the step of requiring that the entity verify the integrity of the data representative of the starting and/or updated information.

22. The method for evaluating a cost payable by an entity to secure a specific coverage according to claim 16 further comprising the step of spot checking the integrity of the data representative of the starting and/or updated information by using at least one instrument to generate test data that is representative of the starting and/or updated information and making a comparison between the test data and the data representative of the starting and updated information that was communicated to the database.

23. The method for evaluating a cost payable by an entity to secure a specific coverage according to claim 1 further comprising the step of providing web-accessible, health-related information for the entity.

24. The method for evaluating a cost payable by an entity to secure a specific coverage according to claim 1 further comprising the step of providing a web-accessible database to which the starting and/or updated information is communicated via the Internet.

25. The method for evaluating a cost payable by an entity to secure a specific coverage according to claim 23 further comprising the step of providing a server to which the data is communicated and containing general health-related information which is accessible by the entity.

26. The method for evaluating a cost payable by an entity to secure a specific coverage according to claim 25 further comprising the step of providing customized health-related information to the entity based upon data communicated by the entity to the server.

27. The method for evaluating a cost payable by an entity to secure a specific coverage according to claim 3 further comprising the step of providing a server and wherein the step of requiring use of an instrument comprises requiring use of an instrument that is capable of taking a measurement and generating a signal to the server that is not in human readable form and causing the signal to be converted by the server to a human readable form.

28. The method for evaluating a cost payable by an entity to secure a specific coverage according to claim 1 wherein the first calculated amount is at least one of (a) a co-payment amount, (b) a deductible, and (c) a premium.

29. The method for evaluating a cost payable by an entity to secure a specific coverage according to claim 1 wherein the entity comprises a single person.

30. The method for evaluating a cost payable by an entity to secure a specific coverage according to claim 1 wherein the entity comprises a plurality of persons.

31. A system for evaluating cost payable by an entity to secure a specific health care coverage, the system comprising:
a server at a first site; and
an instrument at a second site capable of taking at least one measurement and generating a signal representative of a state for at least one health-related attribute for an entity to the server,
the server capable of processing a signal representative of a state for the at least one health-related attribute for the entity and calculating a first recommended amount to be paid by the entity to secure the specific health care coverage based upon a reference amount developed using a reference state for the at least one health-related attribute.

32. The system for evaluating cost payable by an entity to secure a specific health care coverage according to claim 31 wherein the signal generated by the instrument is in non-human readable form and is converted by the server to a human readable form.

33. The system for evaluating cost payable by an entity to secure a specific health care coverage according to claim 31 wherein the server is a web server.

34. The system for evaluating cost payable by an entity to secure a specific health care coverage according to claim 33 wherein the web server communicates health-related information to the entity.

35. The system for evaluating cost payable by an entity to secure a specific health care coverage according to claim 34 wherein the web server communicates customized health-related information to the entity based upon the signals generated to the web server.

36. The system for evaluating cost payable by an entity to secure a specific health care coverage according to claim 31 wherein the web server processes different signals representative of the state for the at least one health-related attribute for the entity at different time periods and processes the different signals to calculate a recommended updated amount appropriate for the entity in the event that a later signal indicates that there is a change in the state for the at least one health-related attribute for the entity from a state for the at least one health-related attribute for the at least one entity based on a signal representative of the state for the at least one health-related attribute for the entity that is generated and communicated to the web server prior in time to the communication of the later signal to the web server.

37. A system for evaluating cost payable by an entity to secure a specific health care coverage, the system comprising:
a server to which data relative to at least one health-related attribute for an entity can be communicated,
the server capable of processing the data communicated by the entity to facilitate risk analysis so as to allow a quantified analysis of an appropriate amount to be paid by the entity for specific health care coverage, based on the communicated information, to be made; and
an instrument for taking at least one measurement to generate data representative of a state for at least one health-related attribute that is communicated to the server.

38. The system for evaluating cost payable by an entity to secure a specific health care coverage according to claim 37 wherein the instrument generates a signal that is not in human readable form and is converted by the server to a human readable form.

39. The system for evaluating cost payable by an entity to secure a specific health care coverage according to claim 37 wherein the server communicates health-related information to the entity.

40. The for evaluating cost payable by an entity to secure a specific health care coverage according to claim 37 wherein the server communicates customized health-related information to the entity based upon the signals generated to the server.

41. The system for evaluating cost payable by an entity to secure a specific health care coverage according to claim 37 wherein the server processes different signals representative of the state for the at least one health-related attribute for the entity at different time periods and processes the different signals to calculate a recommended updated amount appropriate for the entity in the event that a later signal indicates that there is a change in the state for the at least one health-related attribute for the entity from a state for the at least one health-related attribute for the at least one entity based on a signal representative of the state for the at least one health-related attribute for the entity that is generated and communicated to the web server prior in time to the communication of the later signal to the web server.

42. The system for evaluating cost payable by an entity to secure a specific health care coverage according to claim 37 wherein the sever communicates health-related information to the entity in response to a query from the entity.

43. The system for evaluating cost payable by an entity to secure a specific health care coverage according to claim 37 wherein the server is a web-based server.

44. A method of evaluating a cost payable by one individual in a group, consisting of a plurality of individuals, to secure a specific health care coverage, the method comprising the steps of:
obtaining starting information relative to at least one health-related attribute for the plurality of individuals including the one individual;
based on the starting information making an initial health risk assessment for each of the plurality of individuals including the one individual;
at one point in time charging the one individual a first, calculated amount for the specific health care coverage based upon the initial health risk assessment and compared to the initial health risk assessment for the other individual or individuals in the group;
establishing criteria for the one individual to be able to secure the specific health coverage by paying the first calculated amount; and
at a second point in time, after the first point in time, determining whether the one individual has met the established criteria.

45. The method of evaluating a cost payable by an entity to secure a specific health care coverage according to claim 44 wherein the step of establishing criteria comprises setting health-related goals for the one individual.

46. The method of evaluating a cost payable by an entity to secure a specific health care coverage according to claim 45 wherein the step of setting health-related goals comprises requiring the one individual to achieve specific quantifiable results relative to at least one health-related attribute.

47. The method of evaluating a cost payable by an entity to secure a specific health care coverage according to claim 45 wherein the step of setting health-related goals comprises requiring the one individual to embark upon a specific health-related regimen.

48. The method of evaluating a cost payable by an entity to secure a specific health care coverage according to claim 44 further comprising the steps of obtaining updated information relative to at least one health-related attribute for the one individual, based on the updated information making an updated health risk assessment for the one individual, and charging the one individual a second, calculated amount for the specific health care coverage, that is different than the first, calculated amount, based upon the difference in the initial and updated health risk assessments for the one individual.
